(19) United States
(12) Patent Application Publication
(10) Pub. No.: US 2022/0254253 A1
(43) Pub. Date: Aug. 11, 2022

(54) METHOD AND APPARATUS OF FAILURE MONITORING FOR SIGNAL LIGHTS AND STORAGE MEDIUM

(71) Applicant: APOLLO INTELLIGENT CONNECTIVITY (BEIJING) TECHNOLOGY CO., LTD., Beijing (CN)

(72) Inventors: Wei DAI, Beijing (CN); Mingzhi CHEN, Beijing (CN)

(21) Appl. No.: 17/723,183

(22) Filed: Apr. 18, 2022

(30) Foreign Application Priority Data
May 20, 2021 (CN) 202110553095.X

(51) Int. Cl. G08G 1/097; G08G 1/01

(52) U.S. Cl. CPC G08G 1/097; G08G 1/0125

(57) ABSTRACT

A method and an apparatus of failure monitoring for signal lights, and a storage medium is provided. The method includes: acquiring state information of signal lights fed back by a signal machine in a time period; acquiring an indication state of the signal lights and a traffic flow of the intersection in the time period by parsing data acquired by a monitoring device at an intersection where the signal lights are located in the time period; and determining whether the signal lights are under a failure condition based on the state information of the signal lights, the indication state of the signal lights and the traffic flow of the intersection.

### CROSS REFERENCE TO RELATED APPLICATION

This application is based on and claims priority to Chinese Patent Application No. 202110553095.X, filed on May 20, 2021, the entire content of which is hereby incorporated by reference.

### TECHNICAL FIELD

The disclosure relates to a field of computer technologies, particularly to a field of artificial intelligence (AI) technologies such as computer vision and intelligence transportation, and specifically to a method and an apparatus of failure monitoring for signal lights, and a storage medium.

### BACKGROUND

With increasing of vehicles on the road, signal lights and monitoring devices at intersections play a very important role in modern transportation. However, the signal lights and the monitoring devices sometimes will fail, and delay in dealing with failures may result in traffic chaos and even a serious traffic accident.

### SUMMARY

The disclosure provides a method and an apparatus of failure monitoring for signal lights, and a storage medium.

According to a first aspect of the disclosure, a method of failure monitoring for signal lights is provided, and includes: acquiring state information of signal lights fed back by a signal machine in a time period; acquiring an indication state of the signal lights and a traffic flow of the intersection in the time period by parsing data acquired by a monitoring device at an intersection where the signal lights are located in the time period; and determining whether the signal lights are under a failure condition based on the state information of the signal lights, the indication state of the signal lights and the traffic flow of the intersection.

According to a second aspect of the disclosure, an apparatus of failure monitoring for signal lights is provided, and includes: at least one processor; and a memory communicatively connected to the at least one processor. The memory is stored with instructions executable by the at least one processor, and the at least one processor is configured to: acquire state information of signal lights fed back by a signal machine in a time period; acquire an indication state of the signal lights and a traffic flow of the intersection in the time period by parsing data acquired by a monitoring device at an intersection where the signal lights are located in the time period; and determine whether the signal lights are under a failure condition based on the state information of the signal lights, the indication state of the signal lights and the traffic flow of the intersection.

According to a third aspect of the disclosure, a non-transitory computer readable storage medium stored with computer instructions is provided. The computer instructions are configured to perform a method of failure monitoring for signal lights, and the method includes: acquiring state information of signal lights fed back by a signal machine in a time period; acquiring an indication state of the signal lights and a traffic flow of the intersection in the time period by parsing data acquired by a monitoring device at an intersection where the signal lights are located in the time period; and determining whether the signal lights are under a failure condition, based on the state information of the signal lights, the indication state of the signal lights and the traffic flow of the intersection.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure. Where,

FIG. 1 is a diagram illustrating a first embodiment of the disclosure;

FIG. 2 is a diagram illustrating a second embodiment of the disclosure;

FIG. 3 is a diagram illustrating a third embodiment of the disclosure;

FIG. 4 is a diagram illustrating a fourth embodiment of the disclosure;

FIG. 5 is a diagram illustrating a fifth embodiment of the disclosure;

FIG. 6 is a diagram illustrating a sixth embodiment of the disclosure;

FIG. 7 is a diagram illustrating a seventh embodiment of the disclosure;

FIG. 8 is a diagram illustrating an eighth embodiment of the disclosure;

FIG. 9 is a diagram illustrating a ninth embodiment of the disclosure;

FIG. 10 is a block diagram of an electronic device of a method of failure monitoring for signal lights in the embodiment of the disclosure.

### DETAILED DESCRIPTION

The example embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made on the embodiments described herein without departing from the scope and spirit of the present disclosure. Similarly, for clarity and conciseness, descriptions of well-known functions and structures are omitted in the following descriptions.

The embodiment of the disclosure relates to a field of artificial intelligence (AI) technologies such as computer vision and intelligent transportation.

Artificial Intelligence, abbreviated as AI, is a new science of technology that studies and develops theories, methods, technologies and application systems configured to simulate, extend and expand human intelligence.

Computer vision refers to performing machine vision such as recognition, tracking and measurement on a target by a camera and a computer instead of human eyes, and further performing graphics processing, so as to obtain an image more suitable for human eyes to observe or transmitting to an instrument for detection through computer processing.

Intelligent transportation refers to effectively integrating advanced science and technology (information technology, computer technology, data communication technology, sensor technology, electronic control technology, automatic control theory, operations planning, artificial intelligence, etc.) in traffic transportation, service control and vehicle manufacturing, and strengthening a link among vehicles, roads and users, thereby forming a comprehensive transportation system that guarantees safety, enhances efficiency, improves environment and saves energy.

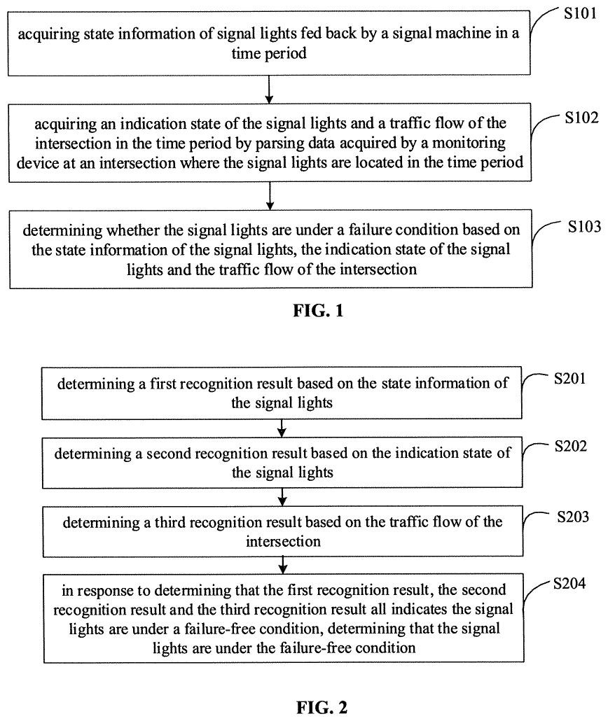

FIG. 1 is a flowchart illustrating a method of failure monitoring for signal lights according to a first embodiment of the disclosure.

For example, the method of failure monitoring for the signal lights in the embodiment may be implemented by an apparatus of failure monitoring for signal lights. The apparatus may be implemented by means of software and/or hardware and may be configured in an electronic device. The electronic device may include but not limited to a terminal, a server side, etc.

As illustrated in FIG. 1, the method of failure monitoring for the signal lights includes the following blocks.

At block S101, state information of signal lights fed back by a signal machine in a time period is acquired.

The time period may be a continuous time period of ten minutes, five minutes or one minute, which is not limited here.

The state information of the signal lights may include an abnormal state and a normal state, and also may include voltage and current of the signal lights, which is not limited here.

At block S102, an indication state of the signal lights and a traffic flow of the intersection in the time period are acquired by parsing data acquired by a monitoring device at an intersection where the signal lights are located in the time period.

For example, vehicles in video data captured by the monitoring device may be recognized to acquire the number of vehicles and a driving direction of each vehicle. Alternatively, signal lights in the video data may also be recognized to acquire colors of the signal lights and a time length of an indication cycle corresponding to each color of the signal lights.

The indication state of the signal lights may include the time length of the indication cycle corresponding to each of a red light, a green light, and a yellow light, which is not limited in the disclosure.

The traffic flow of the intersection may include a traffic flow in each direction of the intersection where the signal lights are located.

At block S103, it is determined whether the signal lights are under a failure condition based on the state information of the signal lights, the indication state of the signal lights and the traffic flow of the intersection.

For example, when a voltage value and a current value in the state information of the signal lights exceed respective normal threshold ranges, it may be considered that the signal lights are under the failure condition. When an error between the time length of the indication cycle of the signal lights in the indication state of the signal lights and a configuration time length acquired by the signal machine is greater than an error threshold, it may be considered that the signal lights are under the failure condition. When the traffic flow in a certain direction in the time period in the traffic flow of the intersection is 0, it may be considered that the signal lights are under the failure condition. Thus, based on any of the state information of the signal lights, the indication state of the signal lights and the traffic flow of the intersection, it may be determined the signal lights are under the failure condition.

Alternatively, when the voltage value and the current value in the state information of the signal lights do not exceed the respective normal threshold ranges, but the indication state of the signal lights is always in a green state in the time period, it may be considered that the signal lights are under the failure condition. Alternatively, when the traffic flow in a certain direction in the time period in the traffic flow of the intersection is 0, but the indication state of the signal lights in the time period is normal, and the voltage value and the current value in the state information of the signal lights do not exceed the respective normal threshold ranges, it may be considered that the signal lights are under a failure-free condition, etc. Therefore, in the disclosure, it may be determined whether the signal lights are under the failure condition based on multidimensional information. For example, in this case of determining that the signal lights are under the failure-free condition based on the state information of the signal lights, and determining that the signal lights are under the failure condition based on the indication state of the signal lights and the traffic flow of the intersection, when an influence of the state information of the signal lights on determining the failure of the signal lights is small, it may be determined that the signal lights are under the failure condition.

It may be noted that the above example is merely an example, and may not be a limitation of the state information of the signal lights, the indication state of the signal lights, the traffic flow of the intersection, and whether the signal lights are under the failure condition in the embodiment of the disclosure.

In the embodiment, the state information of the signal lights fed back by the signal machine in the time period is acquired, and the indication state of the signal lights and the traffic flow of the intersection in the time period are acquired by parsing the data acquired by the monitoring device at the intersection where the signal lights are located in the time period. Based on the state information of the signal lights, the indication state of the signal lights and the traffic flow of the intersection, it is determined whether the signal lights are under the failure condition. Thus, based on multidimensional information, it is determined whether the signal lights are under the failure condition in real time, which improves accuracy and timeliness of the failure monitoring for the signal lights.

FIG. 2 is a diagram illustrating a second embodiment of the disclosure. As illustrated in FIG. 2, determining whether the signal lights are under the failure condition based on the state information of the signal lights, the indication state of the signal lights and the traffic flow of the intersection may include the following blocks.

At block S201, a first recognition result is determined based on the state information of the signal lights.

The first recognition result may include failure or failure-free.

For example, when the voltage value and the current value in the state information of the signal lights exceed the respective normal threshold ranges, the first recognition result is failure, and when the voltage value and the current value in the state information of the signal lights do not exceed the respective normal threshold ranges, the first recognition result is failure-free.

It may be noted that the above examples are only illustrative and may not be a limitation of the state information of the signal lights and the first recognition result in the embodiment of the disclosure.

At block S202, a second recognition result is determined based on the indication state of the signal lights.

The second recognition result may include failure or failure-free.

For example, when the error between the time length of the indication cycle of a red signal light in the indication state of the signal lights and the configuration time length acquired by the signal machine is greater than the error threshold, the second recognition result is failure; when the error between the time length of the indication cycle of each signal light in the indication state of the signal lights and the configuration time length acquired by the signal machine is less than or equal to the error threshold, the second recognition result is failure-free.

It should be noted that the above examples are only illustrative and may not be a limitation of the indication state of the signal lights and the second recognition result in the embodiment of the disclosure.

At block S203, a third recognition result is determined based on the traffic flow of the intersection.

The third recognition result may include failure or failure-free.

For example, when the traffic flow towards a north direction in the time period in the traffic flow of the intersection is 0, and the traffic flow towards an east direction in the time period exceeds a traffic flow in the same time period in historical data, the third recognition result is failure; when the traffic flows respectively towards four directions in the time period in the traffic flow of the intersections are within respective normal ranges, the third recognition result is failure-free.

It should be noted that the above examples are only illustrative and may not be a limitation of the traffic flow of the intersection and the third recognition result in the embodiment of the disclosure.

At block S204, in response to determining that the first recognition result, the second recognition result and the third recognition result all indicates the signal lights are under a failure-free condition, it is determined that the signal lights are under the failure-free condition.

In the embodiment, the first recognition result is determined based on the state information of the signal lights, the second recognition result is determined based on the indication state of the signal lights, and the third recognition result is determined based on the traffic flow of the intersection. In response to determining that the first recognition result, the second recognition result and the third recognition result all indicates the signal lights are under the failure-free condition, it is determined that the signal lights are under the failure-free condition. Thus, based on multidimensional information, it is determined whether the signal lights are under the failure condition in real time, which may improve accuracy and timeliness of the failure monitoring for the signal lights.

FIG. 3 is a diagram illustrating a third embodiment of the disclosure. As illustrated in FIG. 3, determining whether the signal lights are under the failure condition based on the state information of the signal lights, the indication state of the signal lights and the traffic flow of the intersection may include the following blocks.

At block S301, a first recognition result and a first confidence are determined based on the state information of the signal lights.

The first confidence may be configured to reflect a degree of importance of the first recognition result determining based on the state information of the signal lights with respect to determining whether the signal lights are under the failure condition.

At block S302, a second recognition result and a second confidence are determined based on the indication state of the signal lights.

The second confidence may be configured to reflect a degree of importance of the second recognition result determining based on the indication state of the signal lights with respect to determining whether the signal lights are under the failure condition.

At block S303, a third recognition result and a third confidence are determined based on the traffic flow of the intersection.

The third confidence may be configured to reflect the importance of the third recognition result determining based on the traffic flow of the intersection with respect to determining whether the signal lights are under the failure condition.

It should be noted that, the values of the first confidence, the second confidence and the third confidence may be the same, and also may be different, which are not limited here.

At block S304, it is determined whether the signal lights are under the failure condition based on the first recognition result, the second recognition result, the third recognition result and the confidence corresponding to each recognition result.

Optionally, in response to determining that any one of the first recognition result, the second recognition result and the third recognition result indicates that the signal lights are under the failure condition, and the confidence corresponding to the recognition result indicating that the signal lights are under the failure condition is greater than or equal to a first threshold, it is determined that the signal lights are under the failure condition.

For example, the first recognition result indicates that the signal lights are under the failure condition, and the second recognition result and the third recognition result indicate that the signal lights are under the failure-free condition, the first threshold is 0.6, the first confidence corresponding to the first recognition result is 0.8, the first confidence 0.8 is greater than the first threshold 0.6, therefore, it is determined that the signal lights are under the failure condition. It may be noted that, the above examples are only illustrative and may not be a limitation of the first recognition result, the second recognition result, the third recognition result, the first confidence and the first threshold in the embodiment of the disclosure.

Optionally, in response to determining that any one of the first recognition result, the second recognition result and the third recognition result indicates that the signal lights are under the failure condition, and the confidence corresponding to the recognition result indicating that the signal lights are under the failure condition is less than a second threshold, and the confidences corresponding to the recognition results indicating that the signal lights are under a failure-free condition are greater than or equal to a third threshold, it is determined that the signal lights are under the failure-free condition.

For example, the first recognition result indicates that the signal lights are under the failure condition, and the second recognition result and the third recognition result indicate that the signal lights are under the failure-free condition, the first confidence corresponding to the first recognition result is 0.5, the second confidence corresponding to the second recognition result is 0.8, the third confidence corresponding to the third recognition result is 0.9, the second threshold is 0.6, the third threshold is 0.7, the first confidence is smaller than the second threshold, the second confidence and the third confidence are greater than the third threshold, therefore, it is determined that the signal lights are under the failure-free condition.

It may be noted that, the above examples are only illustrative and may not be a limitation of the first recognition result, the second recognition result, the third recognition result, the first confidence, the second confidence, the third confidence, the second threshold and the third threshold in the embodiment of the disclosure.

In the embodiment, the first recognition result and the first confidence are determined based on the state information of the signal lights, the second recognition result and the second confidence are determined based on the indication state of the signal lights, the third recognition result and the third confidence are determined based on the traffic flow of the intersection. Based on the first recognition result, the second recognition result, the third recognition result and the confidence corresponding to each recognition result, it is determined whether the signal lights are under the failure condition. Thus, based on the recognition result of multidimensional information and the corresponding confidence, it is determined whether the signal lights are under the failure condition in real time, which further improves accuracy of the failure monitoring for the signal lights.

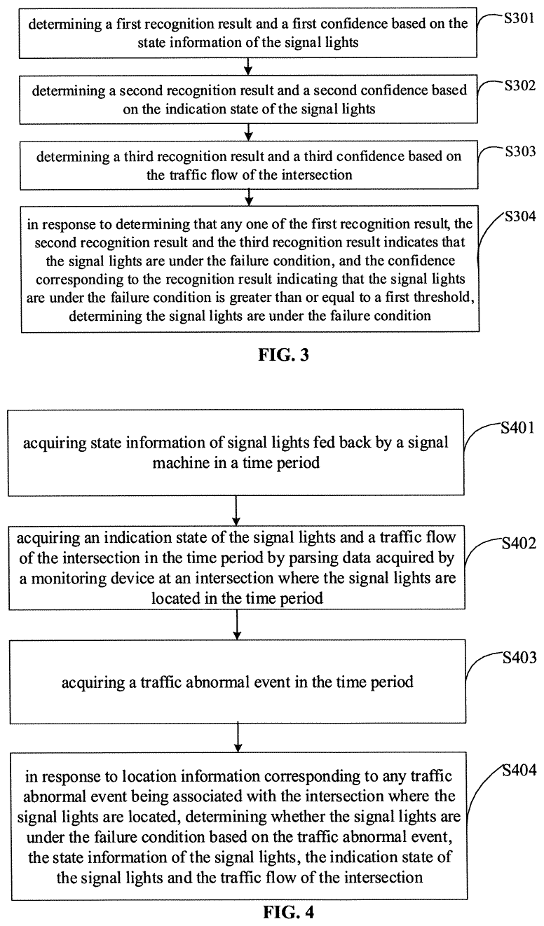

FIG. 4 is a diagram illustrating a fourth embodiment of the disclosure. As illustrated in FIG. 4, the method of failure monitoring for the signal lights provided in the disclosure includes the following blocks.

At block S401, state information of signal lights fed back by a signal machine in a time period is acquired.

At block S402, an indication state of the signal lights and a traffic flow of the intersection in the time period are acquired by parsing data acquired by a monitoring device at an intersection where the signal lights are located in the time period.

The specific implementation manner of blocks S401 and S402 may refer to the description of other embodiments of the disclosure, which is not repeated here.

At block S403, a traffic abnormal event in the time period is acquired.

For example, based on data provided by traffic police, data provided by map software, or data in a traffic abnormality reporting system, the traffic abnormal event in the time period and location information where the traffic abnormal event occurs may be acquired, which is not limited in the disclosure.

At block S404, in response to the location information corresponding to any traffic abnormal event being associated with the intersection where the signal lights are located, it is determined whether the signal lights are under the failure condition based on the traffic abnormal event, the state information of the signal lights, the indication state of the signal lights and the traffic flow of the intersection.

In some embodiments, a first recognition result is determined based on the state information of the signal lights, a second recognition result is determined based on the indication state of the signal lights, a third recognition result is determined based on the traffic flow of the intersection, and a fourth recognition result is determined based on the traffic abnormal event. Thus, in response to determining that the first recognition result, the second recognition result, the third recognition result and the fourth recognition result all indicate that the signal lights are under the failure-free condition, it is determined that the signal lights are under the failure-free condition.

In some embodiments, a first recognition result and a first confidence are determined based on the state information of the signal lights, a second recognition result and a second confidence are determined based on the indication state of the signal lights, a third recognition result and a third confidence are determined based on the traffic flow of the intersection, a fourth recognition result and a fourth confidence are determined. Thus, it is determined whether the signal lights are under the failure condition based on the first recognition result, the second recognition result, the third recognition result, the fourth recognition result and the confidence corresponding to each recognition result.

In the embodiment, the state information of the signal lights fed back by the signal machine in the time period is acquired, and the indication state of the signal lights and the traffic flow of the intersection in the time period are acquired by parsing the data acquired by the monitoring device at the intersection where the signal lights are located in the time period, and the traffic abnormal event in the time period is acquired. In response to the location information corresponding to any traffic abnormal event being associated with the intersection where the signal lights are located, it is determined whether the signal lights are under the failure condition based on the traffic abnormal event, the state information of the signal lights, the indication state of the signal lights and the traffic flow of the intersection. Thus, based on multidimensional information such as the traffic abnormal event, the state information of the signal lights, the indication state of the signal lights and the traffic flow of the intersection, it is determined whether the signal lights are under the failure condition in real time, which further improves accuracy of the failure monitoring for the signal lights.

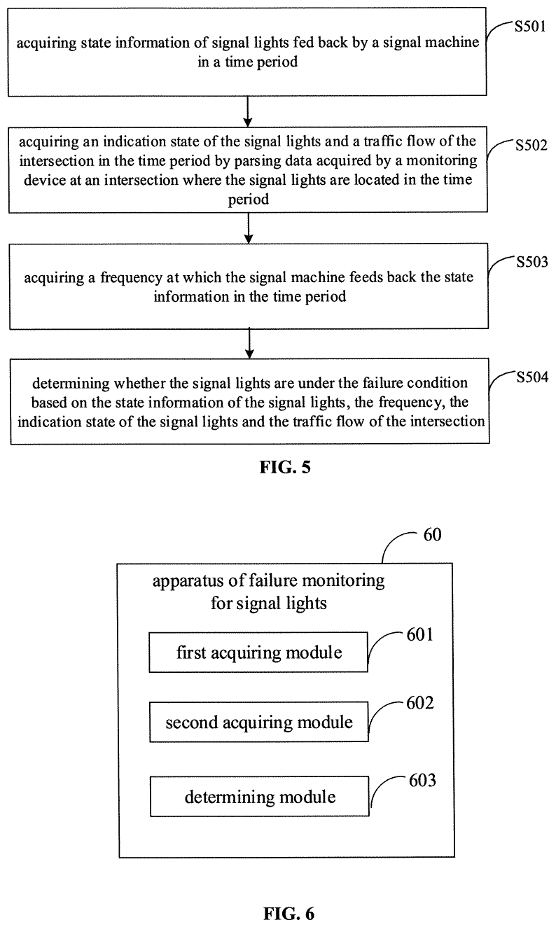

FIG. 5 is a diagram illustrating a fifth embodiment of the disclosure. As illustrated in FIG. 5, the method of the failure monitoring for the signal lights provided in the disclosure includes the following blocks.

At block S501, state information of signal lights fed back by a signal machine in a time period is acquired.

At block S502, an indication state of the signal lights and a traffic flow of the intersection in the time period are acquired by parsing data acquired by a monitoring device at an intersection where the signal lights are located in the time period.

The specific implementation mode of blocks S501 and S502 may refer to the description of other embodiments of the disclosure, which is not repeated here.

At block S503, a frequency at which the signal machine feeds back the state information in the time period is acquired.

At block S504, it is determined whether the signal lights are under the failure condition based on the state information of the signal lights, the frequency, the indication state of the signal lights, and the traffic flow of the intersection.

In some embodiments, a first recognition result is determined based on the state information of the signal lights, a second recognition result is determined based on the indication state of the signal lights, a third recognition result is determined based on the traffic flow of the intersection, and a fifth recognition result is determined based on the frequency, thus, in response to determining that the first recognition result, the second recognition result, the third recognition result and the fifth recognition result all indicates that the signal lights are under the failure-free condition, it is determined that the signal lights are under the failure-free condition.

In some embodiments, a first recognition result and a first confidence are determined based on the state information of the signal lights, a second recognition result and a second confidence are determined based on the indication state of the signal lights, a third recognition result and a third confidence are determined based on the traffic flow of the intersection; a fifth recognition result and a fifth confidence are determined based on the frequency, thus, based on the first recognition result, the second recognition result, the third recognition result, the fifth recognition result and the confidence corresponding to each recognition result, it is determined whether the signal lights are under the failure condition.

In the embodiment, the state information of the signal lights fed back by the signal machine in the time period is acquired, and the indication state of the signal lights and the traffic flow of the intersection in the time period are acquired by parsing the data acquired by the monitoring device at the intersection where the signal lights are located in the time period, and the frequency at which the signal machine feeds back the state information in the time period is acquired. In response to the location information corresponding to any traffic abnormal event being associated with the intersection where the signal lights are located, it is determined whether the signal lights are under the failure condition based on the state information of the signal lights, the frequency, the indication state of the signal lights and the traffic flow of the intersection. Thus, based on multidimensional information such as the frequency at which the signal machine feeds back the state information in the time period, the state information of the signal lights, the indication state of the signal lights and the traffic flow of the intersection, it is determined whether the signal lights are under the failure condition in real time, which further improves accuracy of the failure monitoring for the signal lights.

FIG. 6 is a diagram illustrating a sixth embodiment of the disclosure; as illustrated in FIG. 6, the apparatus 60 of failure monitoring for the signal lights includes a first acquiring module 601, a second acquiring module 602 and a determining module 603.

The first acquiring module 601 is configured to state information of signal lights fed back by a signal machine in a time period. The second acquiring module 602 is configured to acquire an indication state of the signal lights and a traffic flow of the intersection in the time period by parsing data acquired by a monitoring device at an intersection where the signal lights are located in the time period. The determining module 603 is configured to determine whether the signal lights are under a failure condition based on the state information of the signal lights, the indication state of the signal lights and the traffic flow of the intersection.

In some embodiments, the determining module 603 is configured to: determine a first recognition result based on the state information of the signal lights; determine a second recognition result based on the indication state of the signal lights; determine a third recognition result based on the traffic flow of the intersection; and in response to determining that the first recognition result, the second recognition result and the third recognition result all indicates the signal lights are under a failure-free condition, determine that the signal lights are under the failure-free condition.

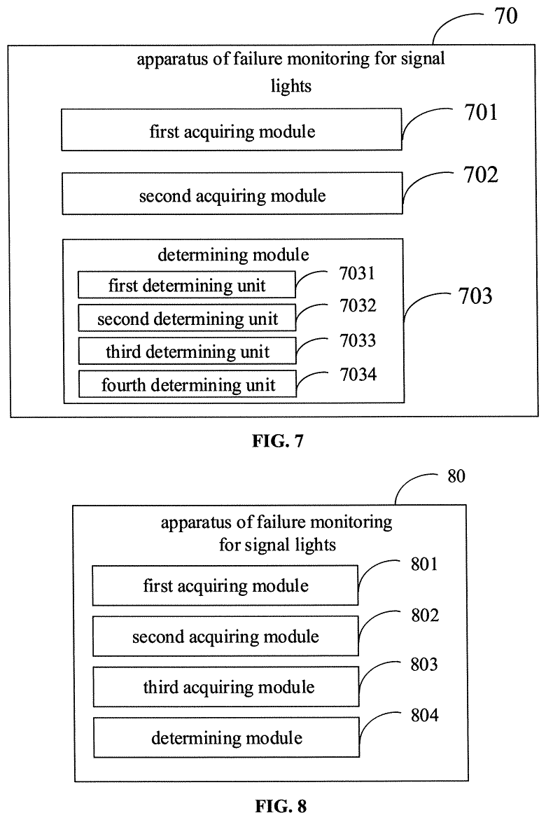

In some embodiments of the disclosure, FIG. 7 is a diagram illustrating a seventh embodiment of the disclosure. As illustrated in FIG. 7, the apparatus 70 of failure monitoring for the signal lights includes a first acquiring module 701, a second acquiring module 702 and a determining module 703. The determining module 703 includes a first determining unit 7031, a second determining unit 7032, a third determining unit 7033 and a fourth determining unit 7034.

The first determining unit 7031 is configured to determine a first recognition result and a first confidence based on the state information of the signal lights. The second determining unit 7032 is configured to determine a second recognition result and a second confidence based on the indication state of the signal lights. The third determining unit 7033 is configured to determine a third recognition result and a third confidence based on the traffic flow of the intersection. The fourth determining unit 7034 is configured to, in response to determining that any one of the first recognition result, the second recognition result and the third recognition result indicates that the signal lights are under the failure condition, and the confidence corresponding to the recognition result indicating that the signal lights are under the failure condition is greater than or equal to a first threshold, determine the signal lights are under the failure condition.

In some embodiments of the disclosure, the fourth determining unit 7034 is configured to: in response to determining that any one of the first recognition result, the second recognition result and the third recognition result indicates that the signal lights are under the failure condition, and the confidence corresponding to the recognition result indicating that the signal lights are under the failure condition is less than a second threshold, and the confidences corresponding to the recognition results indicating that the signal lights are under a failure-free condition are greater than or equal to a third threshold, determine that the signal lights are under the failure-free condition.

In some embodiments of the disclosure, FIG. 8 is a diagram illustrating an eighth embodiment of the disclosure. As illustrated in FIG. 8, the apparatus 80 of failure monitoring for the signal lights includes a first acquiring module 801, a second acquiring module 802, a third acquiring module 803 and a determining module 804.

The third acquiring module 803 is configured to acquire a traffic abnormal event in the time period. The determining module 804 is configured to, in response to location information corresponding to any traffic abnormal event being associated with the intersection where the signal lights is located, based on the traffic abnormal event, the state information of the signal lights, the indication state of the signal lights and the traffic flow of the intersection, determine whether the signal lights are under the failure condition.

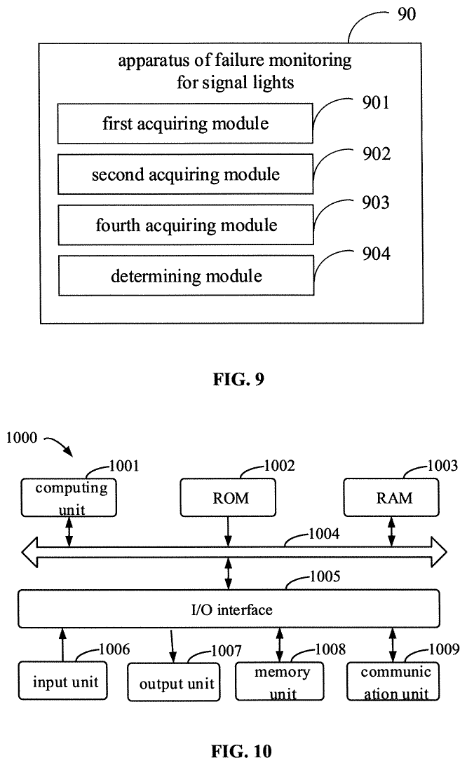

In some embodiments of the disclosure, FIG. 9 is a diagram illustrating a ninth embodiment of the disclosure. As illustrated in FIG. 9, the apparatus 90 of failure monitoring for the signal lights includes a first acquiring module 901, a second acquiring module 902, a fourth acquiring module 903 and a determining module 904.

The fourth acquiring module 903 is configured to acquire a frequency at which the signal machine feeds back the state information in the time period. The determining module 904 is configured to, based on the state information of the signal lights, the frequency, the indication state of the signal lights, and the traffic flow of the intersection, determine whether the signal lights are under the failure condition.

It may be understood that, the apparatus 60 of failure monitoring for the signal lights, the apparatus 70 of failure monitoring for the signal lights, the apparatus 80 of failure monitoring for the signal lights and the apparatus 90 of failure monitoring for the signal lights, the first acquiring module 601, the first acquiring module 701, the first acquiring module 801 and the first acquiring module 901, the second acquiring module 602, the second acquiring module 702, the second acquiring module 802 and the second acquiring module 902, the determining module 603, the determining module 703, the determining module 804, and the determining module 904, may have the same function and structure.

It should be noted that, the description of the method of failure monitoring for the signal lights is applied to an apparatus of failure monitoring for signal lights, which will not be repeated here.

In the embodiment, first, the state information of signal lights fed back by the signal machine in the time period is acquired, then, the indication state of the signal lights and the traffic flow of the intersection in the time period are acquired by parsing the data acquired by the monitoring device at the intersection where the signal lights are located in the time period, and finally, based on the state information of the signal lights, the indication state of the signal lights and the traffic flow of the intersection, it is determined whether the signal lights are under the failure condition. Thus, based on multidimensional information, it is determined whether the signal lights are under the failure condition in real time, which improves accuracy and timeliness of the failure monitoring for the signal lights.

According to the embodiment of the disclosure, the disclosure further provides an electronic device, a readable storage medium and a computer program product.

FIG. 10 illustrates a schematic block diagram of an example electronic device 1000 configured to implement the embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 10, the device 1000 includes a computing unit 1001, which may execute various appropriate actions and processings based on a computer program stored in a read-only memory (ROM) 1002 or a computer program loaded into a random access memory (RAM) 1003 from a storage unit 10010. In the RAM 1003, various programs and data required for operation of the device 1000 may also be stored. The computing unit 1001, the ROM 1002, and the RAM 1003 are connected to each other through a bus 1004. An input/output (I/O) interface 1005 is also connected to a bus 1004.

Several components in the device 1000 are connected to the I/O interface 1005, and include: an input unit 10010, for example, a keyboard, a mouse, etc.; an output unit 1007, for example, various types of displays, speakers, etc.; a storage unit 1008, for example, a magnetic disk, an optical disk, etc.; and a communication unit 1009, for example, a network card, a modem, a wireless communication transceiver, etc. The communication unit 1009 allows the device 1000 to exchange information/data with other devices over a computer network such as the Internet and/or various telecommunication networks.

The computing unit 1001 may be various general-purpose and/or special-purpose processing components with processing and computing capacities. Some examples of a computing unit 1001 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1001 performs various methods and processings as described above, for example, a method for recognizing a dynamic gesture. For example, in some embodiments, a method for recognizing a dynamic gesture may be further implemented as a computer software program, which is physically contained in a machine readable medium, such as a memory unit 1008. In some embodiments, some or all of the computer programs may be loaded and/or mounted on the device 1000 via a ROM 1002 and/or a communication unit 1009. When the computer program is loaded to a RAM 1003 and performed by a computing unit 1001, one or more blocks in the method for recognizing a dynamic gesture as described above may be performed. Alternatively, in other embodiments, a computing unit 1001 may be configured to perform a method for recognizing a dynamic gesture in other appropriate ways (for example, by virtue of a firmware).

Various implementation modes of the systems and technologies described above may be implemented in a digital electronic circuit system, a field programmable gate array (FPGA), an application-specific integrated circuit (ASIC), an application specific standard product (ASSP), a system-on-chip (SOC) system, a complex programmable logic device, a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, also known as a cloud computing server or a cloud host, is a host product in a cloud computing service system, to solve the shortcomings of large management difficulty and weak business expansibility existed in the conventional physical host and Virtual Private Server (VPS) service. A server further may be a server with a distributed system, or a server in combination with a blockchain.

In the embodiment, first, the state information of signal lights fed back by the signal machine in the time period is acquired, then, the indication state of the signal lights and the traffic flow of the intersection in the time period are acquired by parsing the data acquired by the monitoring device at the intersection where the signal lights are located in the time period, and finally, based on the state information of the signal lights, the indication state of the signal lights and the traffic flow of the intersection, it is determined whether the signal lights are under the failure condition. Thus, based on multidimensional information, it is determined whether the signal lights are under the failure condition in real time, which improves accuracy and timeliness of the failure monitoring for the signal lights.

It should be understood that, various forms of procedures shown above may be configured to reorder, add or delete blocks. For example, blocks described in the disclosure may be executed in parallel, sequentially, or in a different order, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method of failure monitoring for signal lights, comprising:
acquiring state information of signal lights fed back by a signal machine in a time period;
acquiring an indication state of the signal lights and a traffic flow of the intersection in the time period by parsing data acquired by a monitoring device at an intersection where the signal lights are located in the time period; and
determining whether the signal lights are under a failure condition, based on the state information of the signal lights, the indication state of the signal lights and the traffic flow of the intersection.

2. The method of claim 1, wherein determining whether the signal lights are under the failure condition based on the state information of the signal lights, the indication state of the signal lights and the traffic flow of the intersection comprises:
determining a first recognition result based on the state information of the signal lights;
determining a second recognition result based on the indication state of the signal lights;
determining a third recognition result based on the traffic flow of the intersection; and
in response to determining that the first recognition result, the second recognition result and the third recognition result all indicates the signal lights are under a failure-free condition, determining that the signal lights are under the failure-free condition.

3. The method of claim 1, wherein determining whether the signal lights are under the failure condition based on the state information of the signal lights, the indication state of the signal lights and the traffic flow of the intersection comprises:
determining a first recognition result and a first confidence based on the state information of the signal lights;
determining a second recognition result and a second confidence based on the indication state of the signal lights;
determining a third recognition result and a third confidence based on the traffic flow of the intersection; and
in response to determining that any one of the first recognition result, the second recognition result and the third recognition result indicates that the signal lights are under the failure condition, and the confidence corresponding to the recognition result indicating that the signal lights are under the failure condition is greater than or equal to a first threshold, determining the signal lights are under the failure condition.

4. The method of claim 3, after determining the third recognition result and the third confidence, further comprising:
in response to determining that any one of the first recognition result, the second recognition result and the third recognition result indicates that the signal lights are under the failure condition, and the confidence corresponding to the recognition result indicating that the signal lights are under the failure condition is less than a second threshold, and the confidences corresponding to the recognition results indicating that the signal lights are under a failure-free condition are greater than or equal to a third threshold, determining that the signal lights are under the failure-free condition.

5. The method of claim 1, further comprising:
acquiring a traffic abnormal event in the time period;
wherein determining whether the signal lights are under the failure condition based on the state information of the signal lights, the indication state of the signal lights and the traffic flow of the intersection comprises:
in response to location information corresponding to any traffic abnormal event being associated with the intersection where the signal lights are located, determining whether the signal lights are under the failure condition based on the traffic abnormal event, the state information of the signal lights, the indication state of the signal lights and the traffic flow of the intersection.

6. The method of claim 1, further comprising:
acquiring a frequency at which the signal machine feeds back the state information in the time period;
wherein determining whether the signal lights are under the failure condition based on the state information of the signal lights, the indication state of the signal lights and the traffic flow of the intersection comprises:
determining whether the signal lights are under the failure condition based on the state information of the signal lights, the frequency, the indication state of the signal lights and the traffic flow of the intersection.

7. An apparatus of failure monitoring for signal lights, comprising:
at least one processor; and
a memory communicatively connected to the at least one processor; wherein,
the memory is stored with instructions executable by the at least one processor, and the at least one processor is configured to:
acquire state information of signal lights fed back by a signal machine in a time period;
acquire an indication state of the signal lights and a traffic flow of the intersection in the time period by parsing data acquired by a monitoring device at an intersection where the signal lights are located in the time period; and
determine whether the signal lights are under a failure condition based on the state information of the signal lights, the indication state of the signal lights and the traffic flow of the intersection.

8. The apparatus of claim 7, wherein, the at least one processor is configured to:
determine a first recognition result based on the state information of the signal lights;
determine a second recognition result based on the indication state of the signal lights;
determine a third recognition result based on the traffic flow of the intersection; and
in response to determining that the first recognition result, the second recognition result and the third recognition result all indicates the signal lights are under a failure-free condition, determine that the signal lights are under the failure-free condition.

9. The apparatus of claim 7, wherein, the at least one processor is configured to:
determine a first recognition result and a first confidence based on the state information of the signal lights;
determine a second recognition result and a second confidence based on the indication state of the signal lights;
determine a third recognition result and a third confidence based on the traffic flow of the intersection; and
a fourth determining unit, configured to, in response to determining that any one of the first recognition result, the second recognition result and the third recognition result indicates that the signal lights are under the failure condition, and the confidence corresponding to the recognition result indicating that the signal lights are under the failure condition is greater than or equal to a first threshold, determine the signal lights are under the failure condition.

10. The apparatus of claim 9, wherein, the at least one processor is configured to:
in response to determining that any one of the first recognition result, the second recognition result and the third recognition result indicates that the signal lights are under the failure condition, and the confidence corresponding to the recognition result indicating that the signal lights are under the failure condition is less than a second threshold, and the confidences corresponding to the recognition results indicating that the signal lights are under a failure-free condition are greater than or equal to a third threshold, determine that the signal lights are under the failure-free condition.

11. The apparatus of claim 7, wherein the at least one processor is configured to:
a third acquiring module, configured to acquire a traffic abnormal event in the time period; and
the determining module, configured to, in response to location information corresponding to any traffic abnormal event being associated with the intersection where the signal lights are located, determine whether the signal lights are under the failure condition based on the traffic abnormal event, the state information of the signal lights, the indication state of the signal lights and the traffic flow of the intersection.

12. The apparatus of claim 7, wherein the at least one processor is configured to:
acquire a frequency at which the signal machine feeds back the state information in the time period; and
determine whether the signal lights are under the failure condition based on the state information of the signal lights, the frequency, the indication state of the signal lights and the traffic flow of the intersection.

13. A non-transitory computer readable storage medium stored with computer instructions, wherein, the computer instructions are configured to cause a computer to perform a method of failure monitoring for signal lights, and the method comprises:
acquiring state information of signal lights fed back by a signal machine in a time period;
acquiring an indication state of the signal lights and a traffic flow of the intersection in the time period by parsing data acquired by a monitoring device at an intersection where the signal lights are located in the time period; and
determining whether the signal lights are under a failure condition, based on the state information of the signal lights, the indication state of the signal lights and the traffic flow of the intersection.

14. The storage medium of claim 13, wherein determining whether the signal lights are under the failure condition based on the state information of the signal lights, the indication state of the signal lights and the traffic flow of the intersection comprises:
determining a first recognition result based on the state information of the signal lights;
determining a second recognition result based on the indication state of the signal lights;
determining a third recognition result based on the traffic flow of the intersection; and
in response to determining that the first recognition result, the second recognition result and the third recognition result all indicates the signal lights are under a failure-free condition, determining that the signal lights are under the failure-free condition.

15. The storage medium of claim 13, wherein determining whether the signal lights are under the failure condition based on the state information of the signal lights, the indication state of the signal lights and the traffic flow of the intersection comprises:
determining a first recognition result and a first confidence based on the state information of the signal lights;
determining a second recognition result and a second confidence based on the indication state of the signal lights;
determining a third recognition result and a third confidence based on the traffic flow of the intersection; and
in response to determining that any one of the first recognition result, the second recognition result and the third recognition result indicates that the signal lights are under the failure condition, and the confidence corresponding to the recognition result indicating that the signal lights are under the failure condition is greater than or equal to a first threshold, determining the signal lights are under the failure condition.

16. The storage medium of claim 15, wherein after determining the third recognition result and the third confidence, the method further comprises:
in response to determining that any one of the first recognition result, the second recognition result and the third recognition result indicates that the signal lights are under the failure condition, and the confidence corresponding to the recognition result indicating that the signal lights are under the failure condition is less than a second threshold, and the confidences corresponding to the recognition results indicating that the signal lights are under a failure-free condition are greater than or equal to a third threshold, determining that the signal lights are under the failure-free condition.

17. The storage medium of claim 13, wherein the method further comprises:
acquiring a traffic abnormal event in the time period;
wherein determining whether the signal lights are under the failure condition based on the state information of the signal lights, the indication state of the signal lights and the traffic flow of the intersection comprises:
in response to location information corresponding to any traffic abnormal event being associated with the intersection where the signal lights are located, determining whether the signal lights are under the failure condition based on the traffic abnormal event, the state information of the signal lights, the indication state of the signal lights and the traffic flow of the intersection.

18. The storage medium of claim 13, wherein the method further comprises:
acquiring a frequency at which the signal machine feeds back the state information in the time period;
wherein determining whether the signal lights are under the failure condition based on the state information of the signal lights, the indication state of the signal lights and the traffic flow of the intersection comprises:
determining whether the signal lights are under the failure condition based on the state information of the signal lights, the frequency, the indication state of the signal lights and the traffic flow of the intersection.
